(19) United States
(12) Patent Application Publication
(10) Pub. No.: US 2018/0107675 A1
(43) Pub. Date: Apr. 19, 2018

(54) COMMUNICATION SYSTEM, RECORDING DEVICE, AND COMMUNICATION METHOD

(71) Applicant: Panasonic Intellectual Property Management Co., Ltd., Osaka (JP)

(72) Inventors: Nobuhiko ARASHIN, Osaka (JP); Takuji MAEDA, Osaka (JP); Akira YAMASAKI, Osaka (JP)

(21) Appl. No.: 15/844,835

(22) Filed: Dec. 18, 2017

Related U.S. Application Data
(63) Continuation of application No. PCT/JP2016/003007, filed on Jun. 22, 2016.

(30) Foreign Application Priority Data
Jul. 1, 2015 (JP) 2015-132285

(51) Int. Cl. G06F 17/30; H04W 12/06

(52) U.S. Cl. CPC G06F 17/30091; H04W 4/80; H04W 12/06

(57) ABSTRACT

A communication system includes a recording medium and a recording device that writes file data into the recording medium. The recording medium includes a storage that stores configuration information as management information about a file system of the recording medium, and a configuration information updating unit that updates the configuration information. The recording device includes an updating instruction unit that transmits an updating instruction for updating the configuration information based on the file data, to the recording medium, an acquisition unit that acquires the configuration information after transmission of the updating instruction, and a writing unit that writes the file data into the storage based on the configuration information acquired by the acquisition unit.

### BACKGROUND

### 1. Technical Field

The present disclosure relates to a communication system, a recording device, and to a communication method for directly accessing a storage of a recording medium.

### 2. Description of the Related Art

PTL 1 discloses a system that downloads, for example, music to a recording medium such as a memory card in accordance with a method for accessing a service providing terminal.

### CITATION LIST

### Patent Literature

PTL 1: Unexamined Japanese Patent Publication No. 2002-73610

### SUMMARY

The present disclosure provides a communication system, a recording device, and a communication method in which an influence on data in a recording medium is reduced even when communication is disconnected while data is being written into the recording medium.

The communication system of the present disclosure is a communication system that includes a recording medium and a recording device that writes file data into the recording medium. The recording medium includes a storage that stores configuration information as management information about a file system of the recording medium, and a configuration information updating unit that updates the configuration information. The recording device includes an updating instruction unit that transmits an updating instruction for updating the configuration information based on the file data, to the recording medium, an acquisition unit that acquires the configuration information after transmission of the updating instruction, and a writing unit that writes the file data into the storage based on the configuration information acquired by the acquisition unit.

Further, the recording device of the present disclosure is a recording device that writes file data into a storage of a recording medium. The recording device includes an updating instruction unit that causes the recording medium to update configuration information about the recording medium, based on the file data, an acquisition unit that acquires the configuration information updated by the recording medium, and a writing unit that writes the file data into the recording medium based on the configuration information acquired by the acquisition unit. The configuration information is management information about a file system of the recording medium.

Further, a communication method of the present disclosure is for writing file data into a storage of a recording medium. The communication method includes transmitting, updating, acquiring, and writing. In the transmitting, an updating instruction for updating configuration information about the recording medium based on the file data is transmitted. In the updating, the configuration information about the recording medium based on the updating instruction is updated. In the acquiring, the configuration information updated in the updating is acquired. In the writing, the file data is written into the storage based on the configuration information acquired in the acquiring. The configuration information is management information about a file system of the recording medium.

### BRIEF DESCRIPTION OF THE DRAWINGS

FIG. 1 is a system chart illustrating a communication system according to an exemplary embodiment;

FIG. 2 is an external view of a recording device and a recording medium according to the exemplary embodiment;

FIG. 3 is a configuration diagram of the recording device according to the exemplary embodiment;

FIG. 4 is a configuration diagram of the recording medium according to the exemplary embodiment;

FIG. 5 is a sequence diagram of the communication system according to the exemplary embodiment;

FIG. 6 is a display diagram of the recording device according to the exemplary embodiment;

FIG. 7 is a password display diagram of the recording device according to the exemplary embodiment; and

FIG. 8 is a configuration diagram illustrating a storage area of a storage of the recording medium according to the exemplary embodiment.

### DETAILED DESCRIPTION

Hereinafter, an exemplary embodiment will be described in detail with reference to the drawings as appropriate. However, in some cases, detailed description more than necessary may be omitted. For example, in some cases, detailed description of well-known matters or repeated description of substantially the same configuration may be omitted. This is to avoid the following description from being unnecessarily redundant, and to facilitate understanding of those skilled in the art.

Note that the attached drawings and the following description are provided for those skilled in the art to fully understand the present disclosure, and are not intended to limit the subject matter as described in the appended claims.

### Exemplary Embodiment

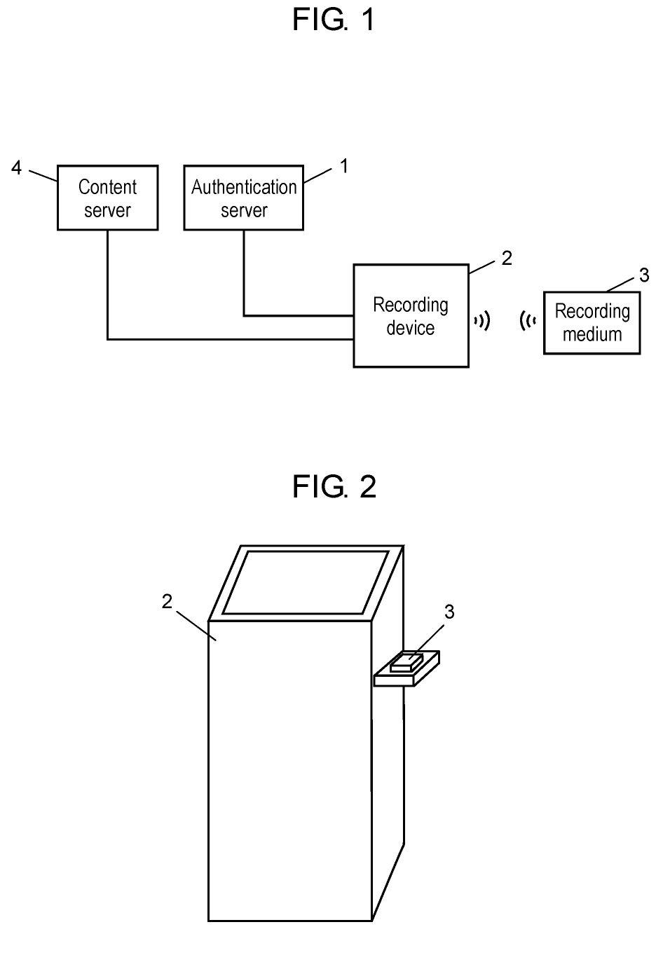

An exemplary embodiment will now be described herein with reference to FIGS. 1 to 8.

### 1-1. Configuration

A configuration of a communication system according to the present exemplary embodiment will be described with reference to FIG. 1 and FIG. 2. FIG. 1 is a system chart of the communication system according to the exemplary embodiment, and FIG. 2 is an external view of a recording device and a recording medium according to the exemplary embodiment.

The communication system according to the present exemplary embodiment includes recording medium 3 that is held by a user and records contents such as music and movies, authentication server 1 that authenticates recording medium 3 and the user, content server 4 that saves contents, and recording device 2 that records the contents in recording medium 3.

Recording device 2 is specifically a terminal disposed on a store front such as a convenience store, namely, like a multimedia information terminal to be used for sales of tickets and contents. Further, recording device 2 downloads the contents to recording medium 3 via wireless communication.

Further, contents are stored in both recording device 2 and content server 4. Contents whose usage frequency is high (new contents) are saved in recording device 2, and contents whose usage frequency is low (old contents) are saved in content server 4. However, the contents may be saved in any one of them.

Recording device 2 and recording medium 3 exchange the contents via wireless communication, and use Wireless Gigabit (WiGig) that is a high-speed wireless communication system utilizing millimeter waves as the wireless communication in the present exemplary embodiment. Further, the contents are read and written by utilizing a WiGig SD Extension Protocol Adaptation Layer (WSDPAL) as a data communication protocol in the present exemplary embodiment.

The WSDPAL means a layer that connects the WiGig to an application utilizing access of a normal SD card.

The use of the WSDPAL enables the application of recording device 2 to regard even a storage in recording medium 3 as a storage of recording device 2. This can make a speed of access from recording device 2 to recording medium 3 higher than a speed of access between normal terminals, and thus the WSDPAL can take an advantage of a communication speed of the WiGig which is a high-speed communication method.

Specifically, conversion of general read and write commands by the WSDPAL enables recording device 2 to access the storage of recording medium 3 as if recording device 2 accesses its own storage.

Further, as illustrated in FIG. 2, recording device 2 has a setting stand where recording medium 3 is set. Recording medium 3 is placed on the setting stand and contents are downloaded therein. At this time, the contents can be downloaded in a stable communication environment. Particularly, when a wireless communication method such as the WiGig having directivity is used like in the present exemplary embodiment, simple placement of recording medium 3 on the setting stand eliminates the need for the user to care about the directivity. Therefore, the use of the WiGig is more effective.

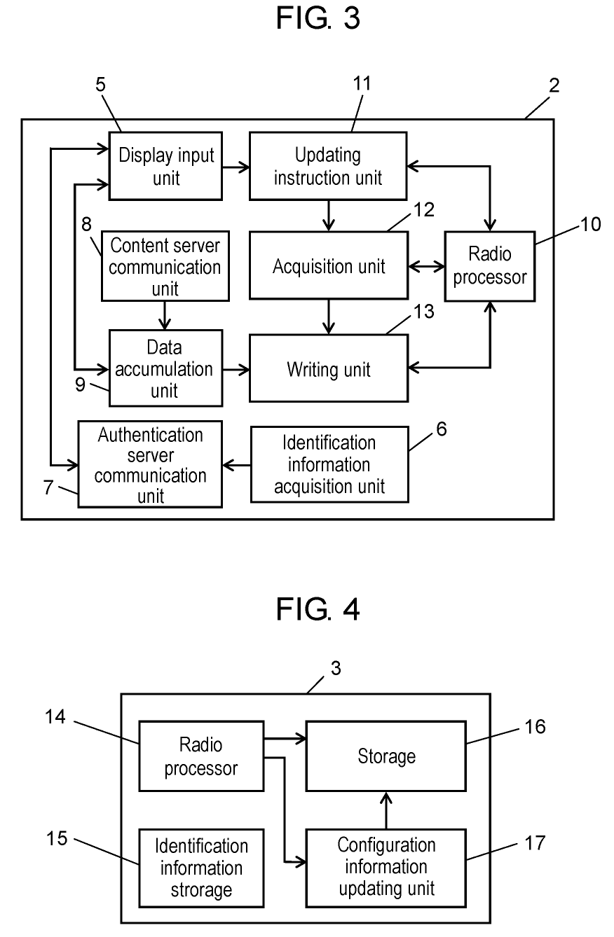

A configuration of recording device 2 will be described below with reference to FIG. 3. FIG. 3 is a configuration diagram of the recording device according to the exemplary embodiment.

Recording device 2 includes display input unit 5, identification information acquisition unit 6, and authentication server communication unit 7. Display input unit 5 allows the user to display and select contents, and to input a password. Identification information acquisition unit 6 acquires identification information about recording medium 3. Authentication server communication unit 7 communicates with authentication server 1 to authenticate the identification information about recording medium 3 acquired from identification information acquisition unit 6 and the password input by display input unit 5.

In the present exemplary embodiment, since radio frequency identification (RFID) is used as the identification information, identification information acquisition unit 6 becomes an RFID reader.

Further, recording device 2 includes data accumulation unit 9 and content server communication unit 8. Data accumulation unit 9 accumulates contents. When the content selected by the user through display input unit 5 is not present in data accumulation unit 9, content server communication unit 8 acquires the content from content server 4.

Further, recording device 2 includes radio processor 10, updating instruction unit 11, acquisition unit 12, and writing unit 13. Radio processor 10 communicates with recording medium 3 via the WiGig. Updating instruction unit 11 instructs recording medium 3 to create an empty temporary file including no data so that the content selected by the user through display input unit 5 is downloaded, and to update configuration information about a file in recording medium 3. Acquisition unit 12 acquires the configuration information about the file in recording medium 3. Writing unit 13, which has a system similar to the file system of recording medium 3, writes file data in recording medium 3 based on the configuration information about the file in recording medium 3 acquired from acquisition unit 12.

A configuration of recording medium 3 will be described below with reference to FIG. 4. FIG. 4 is a configuration diagram of the recording medium according to the exemplary embodiment.

Recording medium 3 is a recording medium that has a communication function and a storage such as a hard disc drive (an HDD) or a nonvolatile memory. Recording medium 3 includes radio processor 14, identification information storage 15 (an RFID tag), storage 16, and configuration information updating unit 17. Radio processor 14 communicates with recording device 2 via the WiGig. Identification information storage 15 (the FRID tag) stores the identification information about recording medium 3. Storage 16 saves contents downloaded from recording device 2 and the configuration information such as configuration information about a file. Configuration information updating unit 17 updates file system information in storage 16 based on the temporary file creating instruction received from recording device 2.

### 1-2. Operation

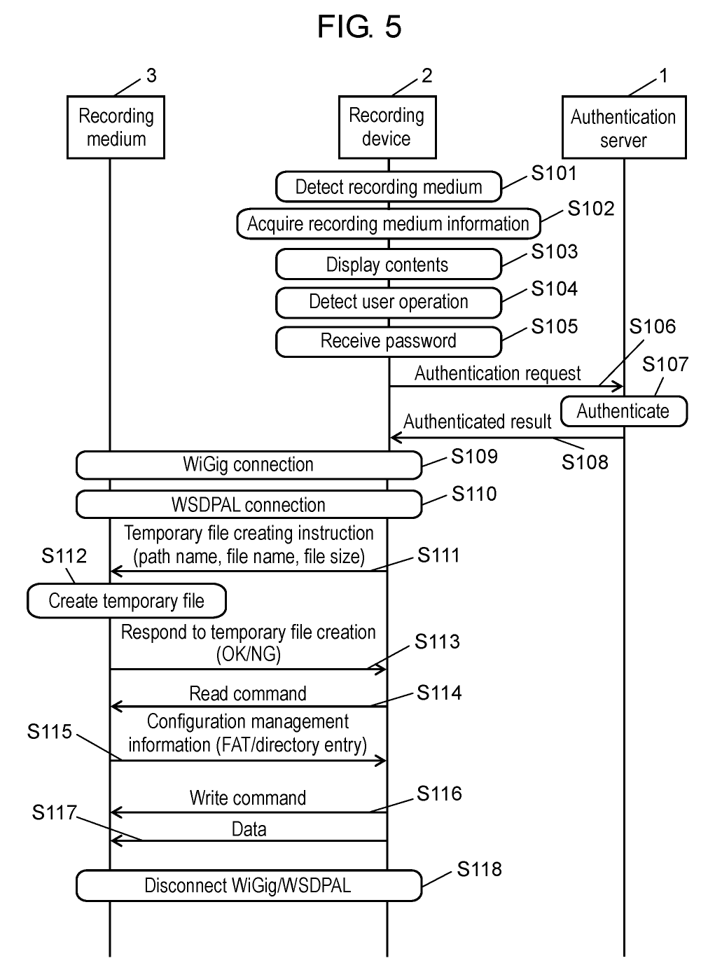

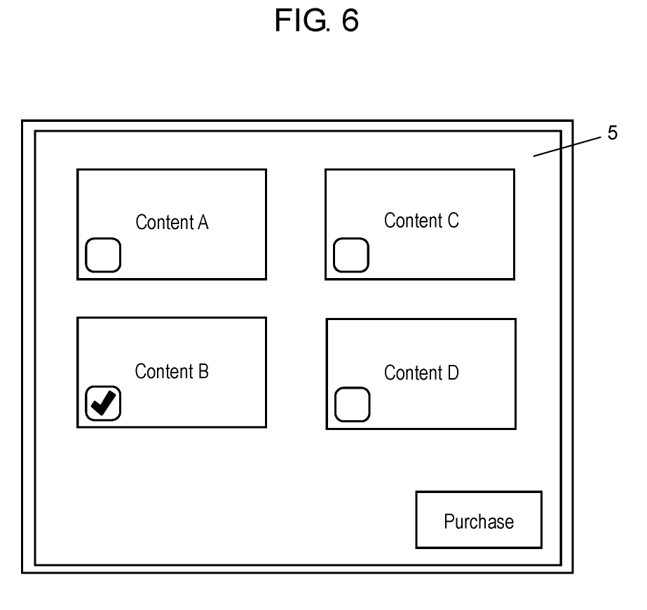

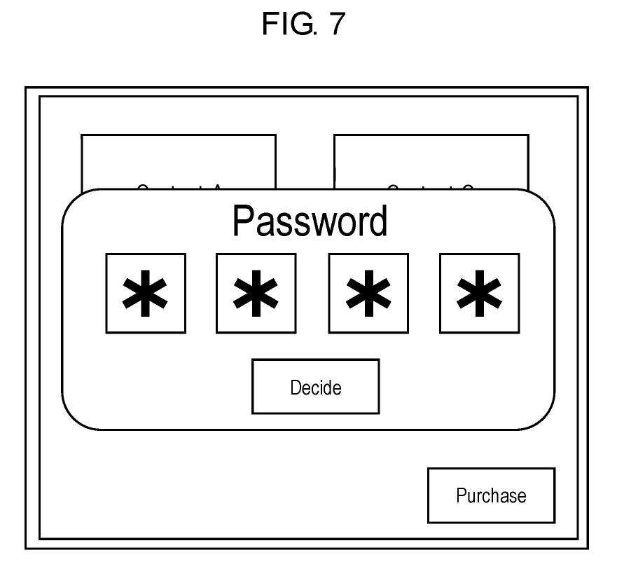

An operation of the communication system having the above configuration will be described below. FIG. 5 is a sequence diagram of the communication system according to the exemplary embodiment, FIG. 6 is a display diagram of the recording device according to the exemplary embodiment, and FIG. 7 is a password display diagram of the recording device according to the exemplary embodiment.

When the user places recording medium 3 on a predetermined position of recording device 2 as illustrated in FIG. 2, recording device 2 detects recording medium 3 (S101), and recording device 2 acquires identification information saved in identification information storage 15 of recording medium 3 (S102). Recording medium 3 may be detected by acquiring the identification information.

Recording device 2 then displays a screen where the user can select a content on display input unit 5 (S103), and detects a user's operation (S104).

Specifically, display illustrated in FIG. 6 is displayed on display input unit 5, and the user selects, for example, content B, and presses down a purchase button to decide purchase of the content. This operation is detected by recording device 2.

If the content detected by this operation is not present in recording device 2, recording device 2 connects to content server 4 to acquire the content.

Recording device 2 then displays a password input screen illustrated in FIG. 7, and causes the user to input a password. This password may be registered in advance by the user before a content download service is started, or may be associated with another service.

When receiving the password (S105), recording device 2 transmits an authentication request including the identification information about recording medium 3 acquired in S102 and the user's password received in S105 to authentication server 1 (S106).

Authentication server 1 executes an authentication process for checking correctness of the user based on the identification information and the password (S107).

Thereafter, authentication server 1 transmits the authenticated result checked in S107 to recording device 2 (S108).

In steps S101 to S108, the user and recording medium 3 are authenticated and a content is selected, but order of these steps is no object.

If the authenticated result has no problem (the correctness is checked), recording device 2 performs wireless connection to recording medium 3. Specifically, WiGig connection is performed (S109), and then WSDPAL connection is performed (S110).

Before writing data of the content selected by the user in S104 (here, content B) in recording medium 3, recording device 2 transmits a path name, a file name, and a file size as the temporary file creating instruction to recording medium 3, based on a saving position predetermined in recording device 2 (S111).

The temporary file creating instruction does not include contents data relating to details of the contents, and is realized by a packet independent from the read command and the write command (in the present exemplary embodiment, an extended packet of the WSDPAL).

Recording medium 3, which has received the temporary file creating instruction from recording device 2, updates the contents of storage 16 using configuration information updating unit 17 of recording medium 3, namely, creates a temporary file (S112).

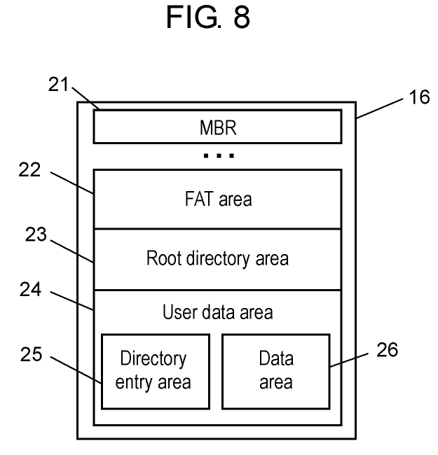

An internal configuration of storage 16 of recording medium 3 will be described herein. FIG. 8 is a configuration diagram illustrating a storage area of the storage of the recording medium according to the exemplary embodiment.

As illustrated in FIG. 8, master boot record (MBR) area 21, a file allocation table (FAT) area, root directory area 23, and user data area 24 are preset in the storage area of storage 16. Partition information or the like is described in MBR area 21. Disposition and configuration information about file data are stored in the FAT area. Information about a root directory is stored in root directory area 23. File data and directory entry are stored in user data area 24.

Further, user data area 24 is configured by directory entry area 25 in which directory entry and file information are stored, and data area 26 in which file data is stored.

In FIG. 8, one file (content) is configured so that configuration information as management information about a file is stored in FAT area 22 and root directory area 23 (or instead of root directory area 23, directory entry area 25), and the file data itself is stored in data area 26.

Therefore, in general, when data is recorded directly in storage 16, both the configuration information and the data of the file are stored in storage 16. That is, in FIG. 8, updating is performed in FAT area 22, root directory area 23, and data area 26, or updating is performed in FAT area 22, directory entry area 25, and data area 26 (writing is performed).

At this time, when recording device 2 directly performs recording using, for example, the WSDPAL, if the communication is disconnected, updating of the configuration information about the file in, for example, FAT area 22 is interrupted. This causes an updating error and thus a defect might occur such that the data in FAT area 22 is corrupted. For example, the configuration information about the file cannot be analyzed, data that is not related to the recorded contents, namely, other data stored in data area 26 cannot occasionally be used.

Therefore, in the present exemplary embodiment, recording device 2 does not directly update the configuration information about the file, that is, FAT area 22, root directory area 23, and directory entry area 25, and thus issues an updating instruction. This prevents the data in FAT area 22, root directory area 23, and directory entry area 25 from being damaged even if the communication is disconnected, for example.

Specifically, recording device 2 issues the temporary file creating instruction including a path name, a file name, and a file size to recording medium 3. Recording medium 3, which has received the instruction, performs updating on FAT area 22, root directory area 23, and directory entry area 25 based on the path name and the file name described in the temporary file creating instruction. The important thing herein is that recording device 2 instructs only the updating to causes recording medium 3 to update the configuration information about the file in storage 16 of itself, and thus recording medium 3 secures only an area in data area 26.

Therefore, even if the communication is disconnected, only the updating instruction is not transmitted, and the disconnection has no influence on the configuration information about the file in storage 16. Therefore, the configuration information about the file can be prevented from being corrupted.

Again with reference to FIG. 5, when the updating in the area of storage 16 upon reception of the temporary file creating instruction is completed in recording medium 3, recording medium 3 returns a temporary file creating response to recording device 2 (S113).

Recording device 2, which has received a notification that creation of a temporary file is completed in recording medium 3, utilizes the WSDPAL to execute a mounting process using recording medium 3 as a memory in recording device 2. As to a subsequent command, a command according to the file system of recording medium 3 is issued, namely, the subsequent command is executed by using a writing algorithm equal to a writing algorithm of configuration information updating unit 17 of recording medium 3.

Specifically, recording device 2 issues the read command via the file system of recording device 2 (S114), and acquires information about FAT area 22 and root directory area 23 of recording medium 3 (S115). When a space in which contents data is to be written is not present in root directory area 23, recording device 2 further acquires information about directory entry area 25.

Recording device 2, which has acquired configuration management information in a state where the temporary file of recording medium 3 is created, issues the write command for downloading the contents data to recording medium 3 (S116), and transmits the data (S117).

When writing is performed with the algorithm equal to the algorithm of configuration information updating unit 17 of recording medium 3, the data is disposed on a position where recording medium 3 disposes the configuration management information and the data information about the file during the temporary file creation. This prevents a discrepancy of data in storage 16 of recording medium 3.

If the writing in data area 26 cannot be performed during the data transmission in S117, when the communication between recording device 2 and recording medium 3 is maintained, recording device 2 instructs updating of the file configuration information (the file is deleted or the temporary file is recreated). When the communication is disconnected, the process is terminated.

When writing of all file data in the content B selected by the user is completed, the WiGig and the WSDPAL are disconnected, and the downloading of the content B to recording medium 3 performed by the user is completed (S118).

At the end, the contents stored in recording medium 3 may be viewed by using a user terminal such as a smartphone via, for example, wireless communication. In another manner, an output unit such as a display or a speaker is provided to recording medium 3 in advance, and thus the contents may be viewed directly on recording medium 3.

### 1-3. Effects and Other Benefits

As described above, even when the communication is disconnected in the present exemplary embodiment, the disconnection has no influence on the configuration information about a file in the recording medium. Therefore, an influence on data in the recording medium can be reduced.

Specifically, wireless communication in which the communication might be disconnected is not used for the configuration information, and thus recording medium 3 itself is caused to update the configuration information to create a temporary file. For this reason, even when a wireless link is disconnected and thus a data gap is caused, the configuration information in storage 16 is not damaged. For this reason, inaccessibility to data area 26 can be prevented, and thus a safe system can be provided.

### Other Exemplary Embodiments

As described above, the exemplary embodiment has been described as an example of the technique disclosed in the present application. However, the technique in the present disclosure is not limited thereto, and can also be applied to embodiments in which change, substitution, addition, omission and the like are performed. Respective constituent elements described in the above exemplary embodiment may be combined to present a new exemplary embodiment.

Accordingly, other exemplary embodiments will be described below.

The WiGig has been used in the above exemplary embodiment, but a wireless system such as Wireless Fidelity (Wi-Fi) may be used, or a wired system may be used. Further, besides the WSDPAL, another PAL such as a universal serial bus PAL may be used.

Further, the FRID that can check identification information has been used in the above exemplary embodiment, but Near Field Communication (NFC), a bar code, or a quick response (QR) code (registered trademark) may be used, or such a code may be applied to a housing of recording medium 3.

Further, in the above exemplary embodiment, different file systems (configuration information about a file) are supposed in recording device 2 and recording medium 3, but the same type of a file system may be used.

Further, in the above exemplary embodiment, the file configuration is FAT, but another file system such as an extended FAT (exFAT) or NT file system (NTFS) can be used.

In the above exemplary embodiment, storage 16 of recording medium 3 is assumed to be a FAT file system, but it goes without saying that any type of a file system can be used.

In the above exemplary embodiment, the temporary file creating instruction and the write command for contents data are separately transmitted, but they may be collectively transmitted.

Further, in the above exemplary embodiment, examples of the contents are music and movies, but may be other data such as map images.

Further, recording medium 3 may be mounted to a terminal such as a smartphone owned by a user.

Further, the respective constituent elements may be formed by using independent circuits, or may be realized by a universal circuit such as a central processing unit (a CPU).

Since the above-described exemplary embodiment is for exemplifying the technique of the present disclosure, various modifications, replacements, additions, and omissions can be made within the scope of the appended claims or their equivalents.

The present disclosure can reduce an influence on data in a recording medium even when communication is disconnected, and is applicable to a content delivery system.

What is claimed is:

1. A communication system comprising:
a recording medium; and
a recording device that writes file data into the recording medium,
wherein
the recording medium includes
a storage that stores configuration information as management information about a file system of the recoding medium, and
a configuration information updating unit that updates the configuration information, and
the recording device includes
an updating instruction unit that transmits an updating instruction for updating the configuration information based on the file data, to the recording medium,
an acquisition unit that acquires the configuration information after transmission of the updating instruction, and
a writing unit that writes the file data into the storage based on the configuration information acquired by the acquisition unit.

2. The communication system according to claim 1, wherein
the file system of the recording medium is different from a file system of the recording device, and
the writing unit writes the file data in accordance with the file system of the recording medium.

3. The communication system according to claim 1, wherein when communication is disconnected while the recording device is writing the file data, the recording medium restores the configuration information or deletes the file data written by the recording device.

4. The communication system according to claim 1, wherein the configuration information is file allocation table (FAT) information.

5. A recording device that writes file data into a storage of a recording medium, the recording device comprising:
an updating instruction unit that causes the recording medium to update configuration information about the recording medium based on the file data;
an acquisition unit that acquires the configuration information updated by the recording medium; and
a writing unit that writes the file data into the recording medium based on the configuration information acquired by the acquisition unit,
wherein the configuration information is management information about a file system of the recording medium.

6. A communication method for writing file data into a storage of a recording medium, the communication method comprising:
transmitting an updating instruction for updating configuration information about the recording medium based on the file data;
updating the configuration information about the recording medium based on the updating instruction;
acquiring the configuration information updated in the updating; and
writing the file data into the storage based on the configuration information acquired in the acquiring,
wherein the configuration information is management information about a file system of the recording medium.
